(19) United States
(12) Patent Application Publication
(10) Pub. No.: US 2007/0154093 A1
(43) Pub. Date: Jul. 5, 2007

(54) Techniques for generating information using a remote control

(76) Inventors: Randy R. Dunton, Phoenix, AZ (US); Lincoln D. Wilde, Portland, OR (US); Brian V. Belmont, West Linn, OR (US); Dale Herigstad, Los Angeles, CA (US); Jason Brush, Los Angeles, CA (US); Carol Soh, Los Angeles, CA (US)

Correspondence Address: KACVINSKY LLC;C/O INTELLEVATE, P.O. BOX 52050, MINNEAPOLIS, MN, 55402, US

(21) Appl. No.: 11/322,937

(22) Filed: Dec. 30, 2005

(51) Int. Cl. G06K 9/18; G09G 5/00

(52) U.S. Cl. 382/186; 345/156

(57) ABSTRACT

Techniques to generate information using a remote control are described. An apparatus may comprise a user interface module to receive movement information representing handwriting from a remote control, and to perform handwriting recognition operations using the movement information. Other embodiments are described and claimed.

### RELATED APPLICATIONS

This application is a related to a commonly owned U.S. patent application Ser. No. ______ titled “A User Interface For A Media Device” and filed on Dec. 30, 2005, and a commonly owned U.S. patent application Ser. No. ______ titled “A User Interface With Software Lensing” and filed on Dec. 30, 2005, which are both incorporated herein by reference.

### BACKGROUND

Consumer electronics and processing systems are converging. Consumer electronics such as televisions and media centers are evolving to include processing capabilities typically found on a computer. The increase in processing capabilities may allow consumer electronics to execute more sophisticated application programs. Such application programs typically require robust user interfaces, capable of receiving user inputs in the form of characters such as text, numbers and symbols. The remote control, however, remains the primary input/output (I/O) device for most consumer electronics. Conventional remote controls are generally unsuitable for entering certain information, such as text information. Accordingly, there may be a need for improved techniques to solve these and other problems.

### BRIEF DESCRIPTION OF THE DRAWINGS

FIG. 1 illustrates one embodiment of a media processing system.

FIG. 2 illustrates one embodiment of a media processing sub-system.

FIG. 3 illustrates one embodiment of a user interface display.

FIG. 4 illustrates one embodiment of a logic flow.

### DETAILED DESCRIPTION

Various embodiments may be directed to techniques to generate information using a remote control. In one embodiment, for example, an apparatus may comprise a user interface module to receive movement information representing handwriting from a remote control. The user interface module may perform handwriting recognition operations using the movement information. The remote control may be arranged to provide movement information as a user moves the remote control through space, such as handwriting characters in the air. In this manner, a user may enter information into a consumer electronic device such as a television or set top box using the remote control, rather than a keyboard or alphanumeric keypad. The type of information capable of being entered by the remote control and user interface module may correspond to the type of information capable of being expressed by a person using ordinary handwriting techniques or shorthand techniques. Examples of such information may include character information, textual information, numeric information, symbol information, and others as described in more detail below. Other embodiments are described and claimed.

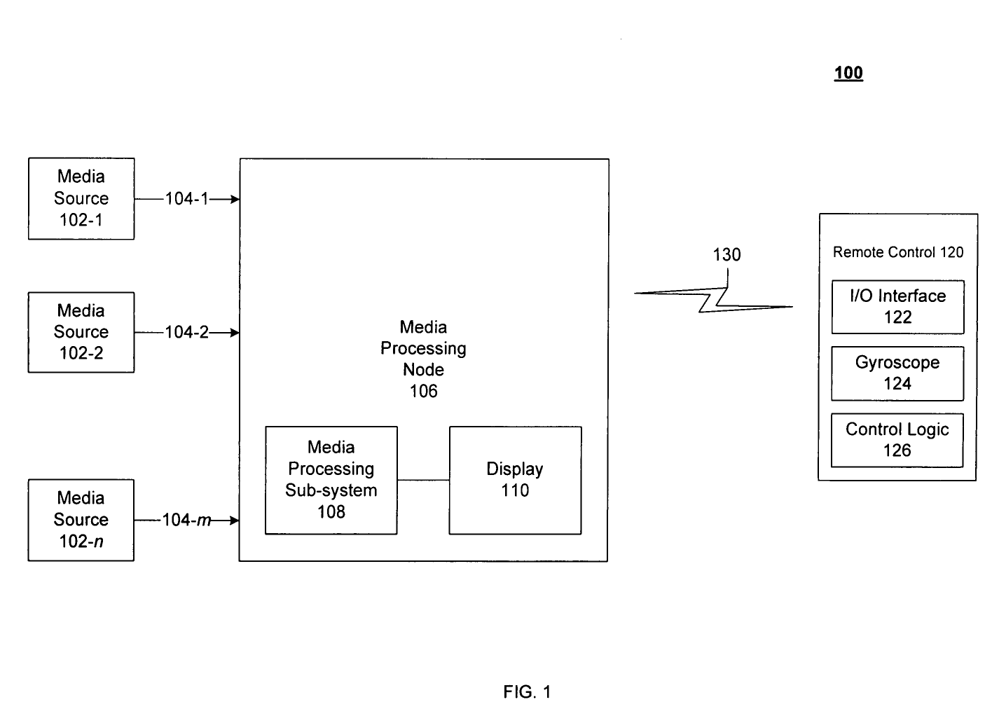

FIG. 1 illustrates one embodiment of a media processing system. FIG. 1 illustrates a block diagram of a media processing system 100. In one embodiment, for example, media processing system 100 may include multiple nodes. A node may comprise any physical or logical entity for processing and/or communicating information in the system 100 and may be implemented as hardware, software, or any combination thereof, as desired for a given set of design parameters or performance constraints. Although FIG. 1 is shown with a limited number of nodes in a certain topology, it may be appreciated that system 100 may include more or less nodes in any type of topology as desired for a given implementation. The embodiments are not limited in this context.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a television, a digital television, a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain f.unction. Examples of a computer language may include C, C++, Java, BASIC, Perl, Matlab, Pascal, Visual BASIC, assembly language, machine code, micro-code for a processor, and so forth. The embodiments are not limited in this context.

In various embodiments, media processing system 100 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the Institute of Electrical and Electronics Engineers (IEEE), the Internet Engineering Task Force (IETF), the Motion Picture Experts Group (MPEG), and so forth. For example, the described embodiments may be arranged to operate in accordance with standards for media processing, such as the National Television Systems Committee (NTSC) standard, the Advanced Television Systems Committee (ATSC) standard, the Phase Alteration by Line (PAL) standard, the MPEG-1 standard, the MPEG-2 standard, the MPEG-4 standard, the Digital Video Broadcasting Terrestrial (DVB-T) broadcasting standard, the DVB Satellite (DVB-S) broadcasting standard, the DVB Cable (DVB-C) broadcasting standard, the Open Cable standard, the Society of Motion Picture and Television Engineers (SMPTE) Video-Codec (VC-1) standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, and so forth. The embodiments are not limited in this context.

In various embodiments, the nodes of media processing system 100 may be arranged to communicate, manage or process different types of information, such as media information and control information. Examples of media information may generally include any data or signals representing content meant for a user, such as media content, voice information, video information, audio information, image information, textual information, numerical information, alphanumeric symbols, graphics, and so forth. Control information may refer to any data or signals representing commands, instructions or control words meant for an automated system. For example, control information may be used to route media information through a system, to establish a connection between devices, instruct a node to process the media information in a predetermined manner, monitor or communicate status, perform synchronization, and so forth. The embodiments are not limited in this context.

In various embodiments, media processing system 100 may be implemented as a wired communication system, a wireless communication system, or a combination of both. Although media processing system 100 may be illustrated using a particular communications media by way of example, it may be appreciated that the principles and techniques discussed herein may be implemented using any type of communication media and accompanying technology. The embodiments are not limited in this context.

When implemented as a wired system, for example, media processing system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The wired communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, media processing system 100 may include one or more wireless nodes arranged to communicate information over one or more types of wireless communication media. An example of wireless communication media may include portions of a wireless spectrum, such as the RF spectrum. The wireless nodes may include components and interfaces suitable for communicating information signals over the designated wireless spectrum, such as one or more antennas, wireless transmitters, receiver, transmitters/receivers (“transceivers”), amplifiers, filters, control logic, antennas, and so forth. The embodiments are not limited in this context.

In various embodiments, media processing system 100 may include one or more media source nodes 102-1-n. Media source nodes 102-1-n may comprise any media source capable of sourcing or delivering media information and/or control information to media processing node 106. More particularly, media source nodes 102-1-n may comprise any media source capable of sourcing or delivering digital audio and/or video (AV) signals to media processing node 106. Examples of media source nodes 102-1-n may include any hardware or software element capable of storing and/or delivering media information, such as a DVD device, a VHS device, a digital VHS device, a personal video recorder, a computer, a gaming console, a Compact Disc (CD) player, computer-readable or machine-readable memory, a digital camera, camcorder, video surveillance system, teleconferencing system, telephone system, medical and measuring instruments, scanner system, copier system, television system, digital television system, set top boxes, personal video records, server systems, computer systems, personal computer systems, digital audio devices (e.g., MP3 players), and so forth. Other examples of media source nodes 102-1-n may include media distribution systems to provide broadcast or streaming analog or digital AV signals to media processing node 106. Examples of media distribution systems may include, for example, Over The Air (OTA) broadcast systems, terrestrial cable systems (CATV), satellite broadcast systems, and so forth. It is worthy to note that media source nodes 102-1-n may be internal or external to media processing node 106, depending upon a given implementation. The embodiments are not limited in this context.

In various embodiments, media processing system 100 may comprise a media processing node 106 to connect to media source nodes 102-1-n over one or more communications media 104-1-m. Media processing node 106 may comprise any node as previously described that is arranged to process media information received from media source nodes 102-1-n. In various embodiments, media processing node 106 may comprise, or be implemented as, one or more media processing devices having a processing system, a processing sub-system, a processor, a computer, a device, an encoder, a decoder, a coder/decoder (codec), a filtering device (e.g., graphic scaling device, deblocking filtering device), a transformation device, an entertainment system, a display, or any other processing architecture. The embodiments are not limited in this context.

In various embodiments, media processing node 106 may include a media processing sub-system 108. Media processing sub-system 108 may comprise a processor, memory, and application hardware and/or software arranged to process media information received from media source nodes 102-1-n. For example, media processing sub-system 108 may be arranged to perform various media operations and user interface operations as described in more detail below. Media processing sub-system 108 may output the processed media information to a display 110. The embodiments are not limited in this context.

In various embodiments, media processing node 106 may include a display 110. Display 110 may be any display capable of displaying media information received from media source nodes 102-1-n. Display 110 may display the media information at a given format resolution. In various embodiments, for example, the incoming video signals received from media source nodes 102-1-n may have a native format, sometimes referred to as a visual resolution format. Examples of a visual resolution format include a digital television (DTV) format, high definition television (HDTV), progressive format, computer display formats, and so forth. For example, the media information may be encoded with a vertical resolution format ranging between 480 visible lines per frame to 1080 visible lines per frame, and a horizontal resolution format ranging between 640 visible pixels per line to 1920 visible pixels per line. In one embodiment, for example, the media information may be encoded in an HDTV video signal having a visual resolution format of 720 progressive (720p), which refers to 720 vertical pixels and 1280 horizontal pixels (720×1280). In another example, the media information may have a visual resolution format corresponding to various computer display formats, such as a video graphics array (VGA) format resolution (640×480), an extended graphics array (XGA) format resolution (1024×768), a super XGA (SXGA) format resolution (1280×1024), an ultra XGA (UXGA) format resolution (1600×1200), and so forth. The embodiments are not limited in this context. The type of displays and format resolutions may vary in accordance with a given set of design or performance constraints, and the embodiments are not limited in this context.

In general operation, media processing node 106 may receive media information from one or more of media source nodes 102-1-n. For example, media processing node 106 may receive media information from a media source node 102-1 implemented as a DVD player integrated with media processing node 106. Media processing sub-system 108 may retrieve the media information from the DVD player, convert the media information from the visual resolution format to the display resolution format of display 110, and reproduce the media information using display 110.

To facilitate operations, media processing sub-system 108 may include a user interface module. The user interface module may allow a user to control certain operations of media processing node 106. For example, assume media processing node 106 comprises a television that has access to an electronic program guide. The electronic program guide may allow a user to view program listings, navigate content, select a program to view, record a program, and so forth. Similar, a media source node 102-1-n may include menu programs to provide user options in viewing or listening to media content reproduced or provided by media source node 102-1-n, and may display the menu options via display 110 of media processing node 106 (e.g., a television display). The user interface module may display user options to a viewer on display 110 in the form of a graphic user interface (GUI), for example. In such cases, a conventional remote control is typically provided to navigate through such basic options.

Consumer electronics and processing systems, however, are converging. Consumer electronics such as televisions and media centers are evolving to include processing capabilities typically found on a computer. The increase in processing capabilities may allow consumer electronics to execute more sophisticated system and application programs. Further, network attachments such as LAN or Internet connections suddenly provide much more media information than previously available on media systems such as televisions. Such increases in media content typically requires more robust user interfaces, capable of receiving user inputs in the form of characters, such as text, numbers and symbols. The remote control, however, remains the primary input/output (I/O) device for most consumer electronics. Conventional remote controls are generally unsuitable for entering certain information, such as text information.

For example, when media processing node 106 is implemented as a television, set top box, or other such consumer electronics platform tied to a screen (e.g., display 110), the user may desire to select among a number of graphically represented media objects such as home videos,.video on demand, photos, music play-lists, and so forth. When selecting from a large set of potential options, it may be desirable to simultaneously convey as many options on display 110 as possible, as well as avoid scrolling among a large set of menu pages. To accomplish this, a user may need to enter text information to accelerate navigation through the options. The text entry may facilitate searching for a particular media object such as a video file, audio file, photograph, television show, movie, application program, and so forth.

Various embodiments may solve these and other problems. Various embodiments may be directed to techniques for generating information using a remote control. In one embodiment, for example, media processing sub-system 108 may include a user interface module to receive movement information representing handwriting from a remote control 120. The user interface module may perform handwriting recognition operations using the movement information. The handwriting recognition operations may convert the handwriting to characters, such as text, numbers or symbols. The text may then be used as user defined input to navigate through the various options and applications provided by media source node 106.

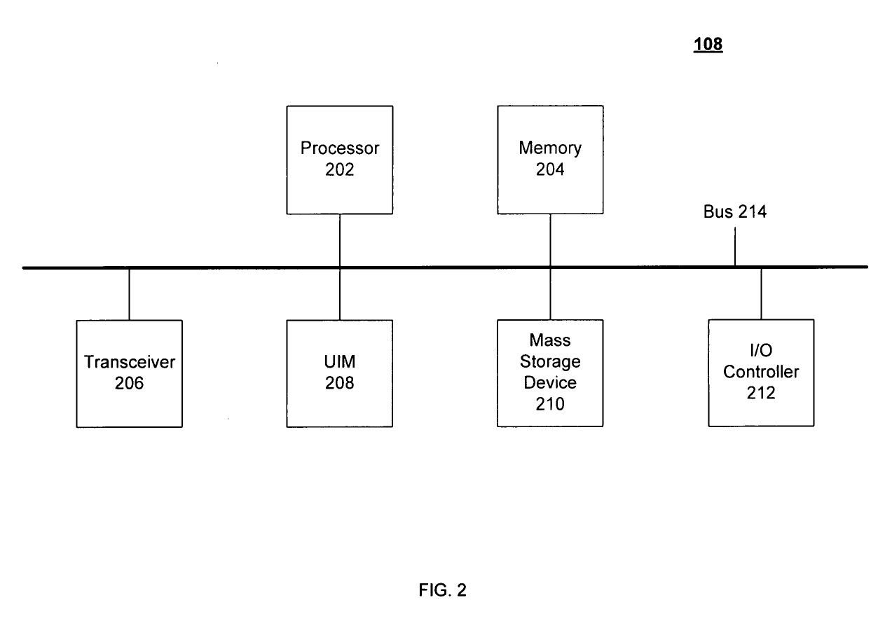

In various embodiments, remote control 120 may be arranged to control, manage or operate media processing node 106 by communicating control information using infrared (IR) or radio-frequency (RF) signals. In one embodiment, for example, remote control 120 may include one or more light-emitting diodes (LED) to generate the infrared signals. The carrier frequency and data rate of such infrared signals may vary according to a given implementation. An infrared remote control may typically send the control information in a low-speed burst, typically for distances of approximately 30 feet or more. In another embodiment, for example, remote control 120 may include an RF transceiver. The RF transceiver may match the RF transceiver used by media processing sub-system 108, as discussed in more detail with reference to FIG. 2. An RF remote control typically has a greater distance than an IR remote control, and may also have the added benefits of greater bandwidth and removing the need for line-of-sight operations. For example, an RF remote control may be used to access devices behind objects such as cabinet doors.

Remote control 120 may control operations for media processing node 106 by communicating control information to media processing node 106. The control information may include one or more IR or RF remote control command codes (“command codes”) corresponding to various operations that the device is capable of performing. The command codes may be assigned to one or more keys or buttons included with an I/O device 122 for remote control 120. I/O device 122 of remote control 120 may comprise various hardware or software buttons, switches, controls or toggles to accept user commands. For example, I/O device 122 may include a numeric keypad, arrow buttons, selection buttons, power buttons, mode buttons, selection buttons, menu buttons, and other controls needed to perform the normal control operations typically found in conventional remote controls. There are many different types of coding systems and command codes, and generally different manufacturers may use different command codes for controlling a given device.

In addition to I/O device 122, remote control 120 may also include elements that allow a user to enter information into a user interface at a distance by moving the remote control through the air in two or three dimensional space. For example, remote control 120 may include a gyroscope 124 and control logic 126. Gyroscope 124 may comprise a gyroscope typically used for pointing devices, remote controls and game controllers. For example, gyroscope 124 may comprise a miniature optical spin gyroscope. Gyroscope 124 may be an inertial sensor arranged to detect natural hand motions to move a cursor or graphic on display 110, such as a television screen or computer monitor. Gyroscope 124 and control logic 126 may be components for an “In Air” or free-space motion-sensing technology that can measure the angle and speed of deviation to move a cursor or other indicator between Point A and Point B, allowing users to select content or enable features on a device waving or pointing remote control 120 in the air. In this arrangement, remote control 120 may be used for various applications, to include providing device control, content indexing, computer pointers, game controllers, content navigation and distribution to fixed and mobile components through a single, hand-held user interface device.

Although some embodiments are described with remote control 120 using a gyroscope 124 by way of example, it may be appreciated that other free-space pointing devices may also be used with remote control 120 or in lieu of remote control 120. For example, some embodiments may use a free-space pointing device made by Hillcrest Labs™ for use with the Welcome HoME™ system, a media center remote control such as Wavlt MC™ made by ThinkOptics, Inc., a game controller such as Wavlt XT™ made by ThinkOptics, Inc., a business presenter such as Wavlt XB™ made by ThinkOptics, Inc., free-space pointing devices using accelerometers, and so forth. The embodiments are not limited in this context.

In one embodiment, for example, gyroscope 124 and control logic 126 may be implemented using the MG1101 and accompanying software and controllers as made by Thomson's Gyration, Inc., Saratoga, Calif. The MG1101 is a dual-axis miniature rate gyroscope that is self-contained for integration into human input devices such as remote control 120. The MG1101 has a tri-axial vibratory structure that isolates the vibrating elements to decrease potential drift and improve shock resistance. The MG1101 can be mounted directly to a printed circuit board without additional shock mounting. The MG1101 uses an electromagnetic transducer design and a single etched beam structure that utilizes the “Coriolis Effect” to sense rotation in two axes simultaneously. The MG1101 includes an integrated analog-to-digital converter (ADC) and communicates via a conventional 2-wire serial interface bus allowing the MG1101 to connect directly to a microcontroller with no additional hardware. The MG1101 further includes memory, such as 1K of available EEPROM storage on board, for example. Although the MG1101 is provided by way of example, other gyroscope technology may be implemented for gyroscope 124 and control logic 126 as desired for a given implementation. The embodiments are not limited in this context.

In operation, a user may enter information into a user interface at a distance by moving remote control 120 through the air. For example, a user may draw or handwrite a letter in the air using cursive or print style of writing. Gyroscope 124 may sense the handwriting movements of remote control 120, and send movement information representing the handwriting movements to media processing node 106 over wireless communications media 130. The user interface module of media processing sub-system 108 may receive the movement information, and perform handwriting recognition operations to convert the handwriting to characters, such as text, numbers or symbols. The characters may be formed into words that may be used by media source node 106 to perform any number of user defined operations, such as searching for content, navigating through options, controlling media source node 106, controlling media source nodes 102-1-n, and so forth. Media processing sub-system 108, and remote control 120, may be described in more detail with reference to FIG. 2.

FIG. 2 illustrates one embodiment of a media processing sub-system 108 FIG. 2 illustrates a block diagram of a media processing sub-system 108 suitable for use with media processing node 106 as described with reference to FIG. 1. The embodiments are not limited, however, to the example given in FIG. 2.

As shown in FIG. 2, media processing sub-system 108 may comprise multiple elements. One or more elements may be implemented using one or more circuits, components, registers, processors, software subroutines, modules, or any combination thereof, as desired for a given set of design or performance constraints. Although FIG. 2 shows a limited number of elements in a certain topology by way of example, it can be appreciated that more or less elements in any suitable topology may be used in media processing sub-system 108 as desired for a given implementation. The embodiments are not limited in this context.

In various embodiments, media processing sub-system 108 may include a processor 202. Processor 202 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 202 may be implemented as a general purpose processor, such as a processor made by Intel® Corporation, Santa Clara, Calif. Processor 202 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, media processing sub-system 108 may include a memory 204 to couple to processor 202. Memory 204 may be coupled to processor 202 via communications bus 214, or by a dedicated communications bus between processor 202 and memory 204, as desired for a given implementation. Memory 204 may be implemented using any machine-readable or computer-readable media capable of storing data, including both volatile and non-volatile memory. For example, memory 204 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 204 may be included on the same integrated circuit as processor 202, or alternatively some portion or all of memory 204 may be disposed on an integrated circuit or other medium, for example a hard disk drive, that is external to the integrated circuit of processor 202. The embodiments are not limited in this context.

In various embodiments, media processing sub-system 108 may include a transceiver 206. Transceiver 206 may be any infrared or radio transmitter and/or receiver arranged to operate in accordance with a desired set of wireless protocols. Examples of suitable wireless protocols may include various wireless local area network (WLAN) protocols, including the IEEE 802.xx series of protocols, such as IEEE 802.11a/b/g/n, IEEE 802.16, IEEE 802.20, and so forth. Other examples of wireless protocols may include various wireless wide area network (WWAN) protocols, such as Global System for Mobile Communications (GSM) cellular radiotelephone system protocols with General Packet Radio Service (GPRS), Code Division Multiple Access (CDMA) cellular radiotelephone communication systems with 1xRTT, Enhanced Data Rates for Global Evolution (EDGE) systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles (collectively referred to herein as “Bluetooth Specification”), and so forth. Other suitable protocols may include Ultra Wide Band (UWB), Digital Office (DO), Digital Home, Trusted Platform Module (TPM), ZigBee, and other protocols. The embodiments are not limited in this context.

In various embodiments, media processing sub-system 108 may include one or more modules. The modules may comprise, or be implemented as, one or more systems, sub-systems, processors, devices, machines, tools, components, circuits, registers, applications, programs, subroutines, or any combination thereof, as desired for a given set of design or performance constraints. The embodiments are not limited in this context.

In various embodiments, media processing sub-system 108 may include a MSD 210. Examples of MSD 210 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, media processing sub-system 108 may include one or more I/O adapters 212. Examples of I/O adapters 212 may include Universal Serial Bus (USB) ports/adapters, IEEE 1394 Firewire ports/adapters, and so forth. The embodiments are not limited in this context.

In one embodiment, for example, media processing sub-system 108 may include various application programs, such as a user interface module (UIM) 208. For example, UIM 208 may comprise a GUI to communicate information between a user and media processing sub-system 108. Media processing sub-system 108 may also include system programs. System programs assists in the running of a computer system. System programs may be directly responsible for controlling, integrating, and managing the individual hardware components of the computer system. Examples of system programs may include operating systems (OS), device drivers, programming tools, utility programs, software libraries, interfaces, program interfaces, API, and so forth. It may be appreciated that UIM 208 may be implemented as software executed by processor 202, dedicated hardware such as a media processor or circuit, or a combination of both. The embodiments are not limited in this context.

In various embodiments, UIM 208 may be arranged to receive user input via remote control 120. Remote control 120 may be arranged to allow a user free-form character entry using gyroscope 124. In this manner a user may enter characters without a keyboard or alphanumeric keypad in a free-hand fashion, similar to a PDA or PC tablet using hand writing recognition techniques. UIM 208 and remote control 120 allow a user to enter the character information even when situated a relatively far distance from display 110, such as 10 feet or more.

In various embodiments, UIM 208 may provide a GUI display on display 110. The GUI display may be capable of displaying handwritten characters corresponding to the movements of remote control 120 as detected by gyroscope 124. This may provide visual feedback to the user as they are generating each character. The type of user input information capable of being entered by remote control 120 and UIM 208 may correspond to any type of information capable of being expressed by a person using ordinary handwriting techniques. Examples of a range of user input information may include the type of information typically available by a keyboard or alphanumeric keypad. Examples of user input information may include character information, textual information, numerical information, symbol information, alphanumeric symbol information, mathematical information, drawing information, graphic information, and so forth. Examples of textual information may include cursive style of handwriting and print style of handwriting. Additional examples of textual information may include uppercase letters and lowercase letters. Furthermore, the user input information may be in different languages having different character, symbol and language sets as desired for a given implementation. UIM 208 may also be capable of accepting user input information in various short hand styles, such as expressing the letter “A” by writing just two of the three vectors, like an inverted “V”, for example. The embodiments are not limited in this context.

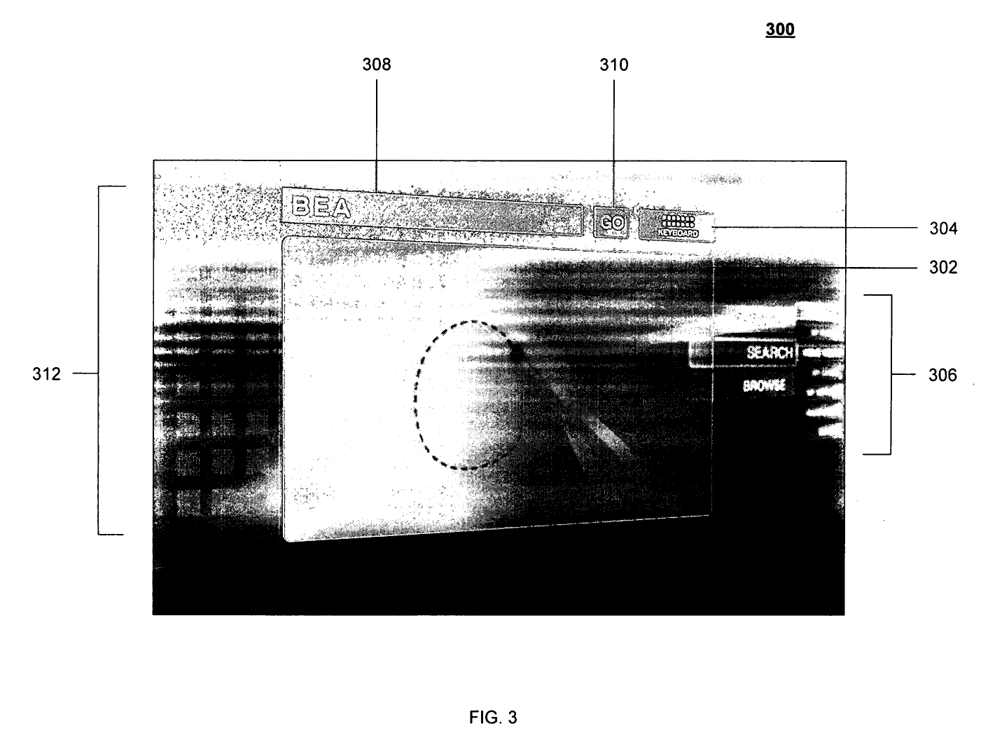

FIG. 3 illustrates one embodiment of a user interface display. FIG. 3 illustrates a user interface display 300. User interface display 300 may provide an example of a GUI display generated by UIM 208. As shown in FIG. 3, user interface display 300 may display different soft buttons and icons controlling various operations of media processing node 106. For example, user interface display 300 may include a drawing pad 302, a keyboard icon 304, various menu buttons 306, a text entry box 308, a command button 310, and various background thumbnails 312. It may be appreciated that the various elements of user interface display 300 are provided by way of example only, and more or less elements in different arrangements may be used by UIM 208 and still fall within the intended scope of the embodiments. The embodiments are not limited in this context.

In operation, user interface display 300 may be presented to a user via display 110 of media processing node 106, or some other display device. A user may use remote control 120 to select a soft button labeled “search” from menu buttons 306. The user may select the search button using remote control 120 as a pointing device similar to an “air” mouse, or through more conventional techniques using I/O interface 122. Once a user selects the search button, user interface display 300 may enter a table mode and present a drawing pad 302 for the user on display 110. When drawing pad 302 is displayed, the user can move and gesture with remote control 120 (or some other free-form pointing device). As the user moves remote control 120, gyroscope 124 moves as well. Control logic 126 may be coupled to gyroscope 124, and generate movement information from the signals received from gyroscope 124. Movement information may comprise any type of information used to measure or record movement of remote control 120. For example, control logic 126 may measure the angle and speed of deviation of gyroscope 124, and output movement information representing the angle and speed of deviation measurements to a transmitter in remote control 120. Remote control 120 may transmit the movement information to UIM 208 via transceiver 206. UIM 208 may interpret the movement information, and move a cursor to draw or render a letter corresponding to the movement information on drawing pad 302.

As shown in FIG. 3, a user may use remote control 120 to draw a letter “C” in the air. Remote control 120 may capture the movement information, and communicate the movement information to media processing node 106 (e.g., via IR or RF communications). Transceiver 206 may receive the movement information, and send it to UIM 208. UIM 208 may receive the movement information, and convert the movement information into handwriting for display by drawing pad 302 of user interface display 300. UIM may render the handwriting on drawing pad 302 using lines of varying thickness and type. For example, the lines may be rendered as solid lines, dashed lines, dotted lines, and so forth. Rendering the handwriting on drawing pad 302 may give the viewer feedback to help coordinate the hand-eye movements to enter characters.

Once the text has been recognized, UIM 208 may perform various handwriting recognition operations to convert the handwriting to text. Once UIM 208 completes the handwriting recognition operations sufficiently to interpret the text corresponding to the user handwriting, UIM 208 confirms the text and enters the character into text entry box 308. As shown in FIG. 3, a user has previously entered the first three characters “BEA” as displayed by text entry box 308 of user interface display 300 in the process of entering the word “BEACH”. Once the user completes forming the letter “C”, UIM 208 may interpret the handwritten letter “C” as an actual letter “C”, and display the confirmed letter “C” in text entry box 308, thereby adding to the existing letters “BEA” to form “BEAC.”

Once the letter, number or symbol has been entered into text entry box 308, UIM 208 may reset display pad 302 by going blank in preparation for receiving the next character from the user via remote control 120. These operations continue until the remaining characters are entered in sequence. Any corrections may be performed using arrow keys or special editing areas of I/O device 122. When completed, the user may select the “go” command button 310 to have media processing node 106 respond to the text entered via UIM 208. For example, when a user enters the final letter “H” and text display box 308 displays the entire word “BEACH,” the user may select command button 310 to have media processing node 106 to search for media information with the word “BEACH” in the identifier. The media information may include various metadata, such as pictures, video files, audio files, movie titles, show titles, electronic book files, and so forth. The embodiments are not limited in this context.

Other techniques may be used to supplement or facilitate the entry of user information into UIM 208. For example, UIM 208 may perform word completion or auto-completion techniques instead of waiting for a user to complete an entire word and select command button 310. As each letter is entered into UIM 208, UIM 208 may provide a list of words having the letter or combination of letters entered by the user. The list of words may narrow as more letters are entered. The user may select a word from the list of words at anytime during the input process. For example, UIM 208 may present a word list such as BEACH, BUNNY and BANANA after the letter “B” has been entered into UIM 208. The user could select the word BEACH from the list without having to enter all the letters of the entire word. This and other shortcut techniques may be implemented to provide a more efficient and responsive user interface for a user, thereby potentially improving the user experience.

In addition to handwriting recognition, UIM 208 may also allow for user input using a soft keyboard. User interface display 300 may include keyboard icon 304. The user can quickly transition from table mode to keyboard mode by selecting keyboard icon 304 on display 110 to switch between the two modes. In keyboard mode, UIM 208 may allow a user to use remote control 120 to enter text by selecting keys on a keyboard represented on display 110. Remote control 120 may control a cursor using either I/O device 122 or gyroscope 124, and a button on I/O device 122 of remote control 120 can “enter” the key under the cursor. UIM 208 may populate text entry box 308 with the selected character.

The table mode of UIM 208 provides several advantages over conventional techniques. For example, conventional techniques require use of a keyboard or an alphanumeric keypad requiring multiple taps to select a letter, such as tapping the “2” key twice to select the letter “B.” By way of contrast, UIM 208 allows a viewer to enter text in an intuitive way without having to take the view from display 110 to remote control 120 or a separate keyboard. The viewer will always be looking at the screen, and may use remote control 120 in any kind of lighting situation. The gesture-based entry provided by remote control 120 could conform to the current character set of a given language. This may be particularly useful for symbol based languages, such as found in various Asian language character sets. UIM 208 may also be arranged to use alternate gesture based character sets (e.g., a “Graffiti” type character set), thereby allowing for short hand text entry as desired for a given implementation. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

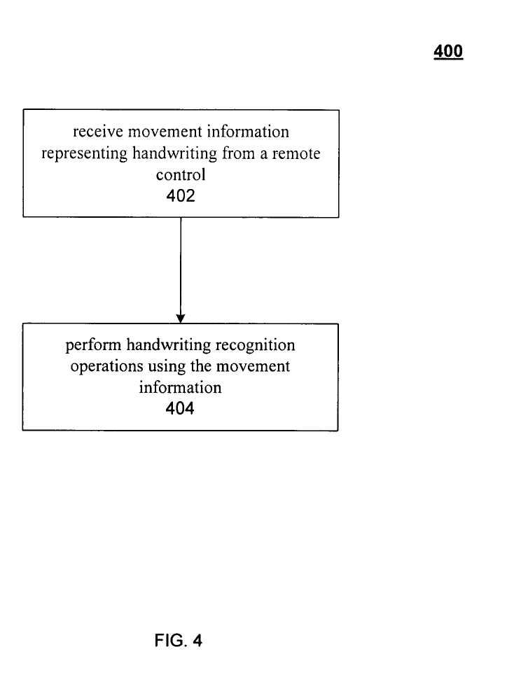

FIG. 4 illustrates one embodiment of a logic flow. FIG. 4 illustrates a logic flow 400. Logic flow 400 may be representative of the operations executed by one or more embodiments described herein, such as media processing node 106, media processing sub-system 108, and/or UIM 208. As shown in logic flow 400, movement information representing handwriting may be received from a remote control at block 402. Handwriting recognition operations may be performed using the movement information at block 404. The embodiments are not limited in this context.

In one embodiment, the movement information may be interpreted as corresponding to movements of the remote control. More particularly, the movement information may be interpreted as corresponding to movements of a gyroscope within the remote control. The embodiments are not limited in this context.

In one embodiment, the handwriting may be converted to characters, such as text, numbers or symbols. The handwriting corresponding to the movement information may also be displayed. The embodiments are not limited in this context.

Numerous specific details have been set forth herein to provide a through understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to memory 406. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intented to cover all such modifications and changes as fall within the true spirit of the embodiments.

1. An apparatus comprising a user interface module to receive movement information representing handwriting from a remote control, and to perform handwriting recognition operations using said movement information.

2. The apparatus of claim 1, said remote control to generate said movement information based on movement of said remote control.

3. The apparatus of claim 1, said remote control having a gyroscope, said gyroscope to generate said movement information based on movement of said remote control.

4. The apparatus of claim 1, said user interface module to convert said handwriting into characters.

5. The apparatus of claim 1, comprising a display to couple to said user interface module, said user interface module to display said handwriting using said display.

6. A system, comprising:
a wireless receiver to receive movement information representing handwriting from a remote control; and
a user interface module to connect to said receiver, said user interface module to perform handwriting recognition operations using said movement information.

7. The system of claim 6, said remote control to generate said movement information based on movement of said remote control.

8. The system of claim 6, said remote control having a gyroscope, said gyroscope to generate said movement information based on movement of said remote control.

9. The system of claim 6, said user interface module to convert said handwriting to characters.

10. The system of claim 6, comprising a display to couple to said user interface module, said user interface module to display said handwriting using said display.

11. A method, comprising:
receiving movement information representing handwriting from a remote control; and
performing handwriting recognition operations using said movement information.

12. The method of claim 11, comprising interpreting said movement information as corresponding to movements of said remote control.

13. The method of claim 11, comprising interpreting said movement information as corresponding to movements of a gyroscope within said remote control.

14. The method of claim 11, comprising converting said handwriting to characters.

15. The method of claim 11, comprising displaying said handwriting corresponding to said movement information.

16. An article comprising a machine-readable storage medium containing instructions that if executed enable a system to receive movement information representing handwriting from a remote control, and perform handwriting recognition operations using said movement information.

17. The article of claim 16, further comprising instructions that if executed enable the system to interpret said movement information as corresponding to movements of said remote control.

18. The article of claim 16, further comprising instructions that if executed enable the system to interpret said movement information as corresponding to movements of a gyroscope within said remote control.

19. The article of claim 16, further comprising instructions that if executed enable the system to convert said handwriting to characters.

20. The article of claim 16, further comprising instructions that if executed enable the system to display said handwriting corresponding to said movement information.
